(19) United States
(12) Patent Application Publication
(10) Pub. No.: US 2004/0053197 A1
(43) Pub. Date: Mar. 18, 2004

(54) Biocompatible implants

(76) Inventors: Zoran Minevski, The Woodlands, TX (US); Carl Nelson, College Station, TX (US)

Correspondence Address: STREETS & STEELE, Suite 355, 13831 Northwest Freeway, Houston, TX, 77040, US

(21) Appl. No.: 10/245,821

(22) Filed: Sep. 16, 2002

(51) Int. Cl. A61C 8/00

(52) U.S. Cl. 433/201.1; 433/173

(57) ABSTRACT

A biocompatible surgical implant for use in human beings and animals. The implant has a titanium or titanium alloy substrate having a surface that has been treated with phosphates. The surface treatment on the implant includes low temperature anodic phosphation of the titanium or titanium alloy substrate. Anodic phosphation changes or modifies the substrate surface through electrochemical reactions between the substrate, acting as an anode, and phosphate ions contained in an electrolyte solution, such as provided by an aqueous solution of phosphoric acid, and water molecules. The surface treatment imparts no significant change in the dimensions of the implant, thereby allowing the surgical implant substrate to be constructed to exact dimensions without having to account for the thickness of additional coatings being applied to the implant.

### BACKGROUND OF THE INVENTION

1. Field of the Invention

The present invention relates to surgical implants, such as surgical implants used in orthopedic surgery and dentistry.

2. Description of the Related Art

Medical implants and prostheses provide structural and mechanical aid or replacement for parts of the body that can no longer provide their intended function. Implants are subject to stress and must bear the required loads without failure. Implants must also be corrosion resistant and biologically compatible with various body tissues, organs and fluids so that they can remain in the body for years.

Implants generally include metal wires, rods, plates, screws, tubes, and other devices. Some implants are attached to bone to reinforce damaged bone in the body. Since they are generally much stiffer than bone, implants can promote stress shielding in the attached bone leading to implant loosening and osteoporosis. Implants presently available will typically have a lifetime of about 7-10 years. While surgical implant replacement is possible, replacement surgery is usually not performed more than once for a particular implant device due to the extent of bone damage created by the first implant. As a result, recommended medical procedures involving implants are generally reserved for people over the age of 40 years. Unfortunately, many younger people injured in accidents could benefit from implants and need implants that will last for many more years than those that are currently available.

Titanium alloys are usually the materials of choice for making surgical implants. In particular, Ti-6V-4Al, a titanium alloy initially developed for aerospace applications, is currently the alloy used to make most orthopedic implants and has been described in various papers and patents. For example, U.S. Pat. No. 4,854,496 describes an implant made by diffusion bonding titanium powder to a titanium or titanium Ti-6Al-4V alloy substrate. The coating provides the implant with enhanced biocompatibility. Additional examples of coated alloy implants now follow.

U.S. Pat. No. 5,763,092 describes orthopedic and dental implants with a crystalline calcium phosphate ceramic coating known as hydroxyapatite. The coating anchors the implant to the existing bone and provides the implant with enhanced biocompatibility, thereby increasing the useful life of the implant and minimizing the likelihood of implant rejection by the body.

Orthopedic and dental implants are commonly coated with a substance to provide a surface suitable for the in-growth of bone tissue, thereby securely anchoring the implant to the existing bone. The biocompatibility of the coating substance further minimizes implant rejection and increases the useful life of the implant. Calcium phosphate ceramics, such as tricalcium phosphate (TCP) and hydroxyapatite (HA), are particularly suitable materials. Hydroxyapatite is particularly preferred since it is a naturally occurring material in bone. However, it is difficult to satisfactorily bond hydroxyapatite to the surface of surgical implants, requiring the application of both heat and pressure. Still, the hydroxyapatite coating is subject to delamination.

Although the Ti-6Al-4V alloy is generally considered to be chemically inert, biocompatible with human tissue, and corrosion resistant to human body fluids and other corrosive environments, vanadium and aluminum are potentially toxic. Normal wear leads to implant degradation and the release of alloy elements into the body. For example, vanadium has been observed in body tissues near Ti-6V-4Al alloy implants.

A more benign replacement for titanium alloy implants may solve the problem of the release of toxic elements into the body from degraded alloy implants. An implant of pure titanium could be the ideal replacement since it is lightweight, chemically and biologically more compatible with human tissue, and can rigidly fixate to bone better than a titanium alloy implant. Unfortunately, pure titanium lacks sufficient strength for general use as an implant material. For example, Ti-6Al-4V alloy has a yield strength of about 795 MPa and an ultimate strength of 860 MPa, whereas the yield strength and ultimate strength for pure titanium are only about 380 MPa and 460 MPa, respectively.

In order to reduce the corrosion rate of implants, various coatings have been applied. For example, U.S. Pat. No. 5,211,833 discloses a method for coating implants with a dense, substantially non-porous oxide coating to minimize the release of corrosion products into the body.

Therefore, there is a need for strong, lightweight, corrosion resistant implants that are chemically and biologically compatible with human fluids and tissue. It would be advantageous if the biocompatibility could be provided through a surface treatment of an implant, wherein the treatment process would not require significant heat or pressure to implement and would not significantly change the overall dimensions of the implant. It would be further advantageous if body tissue would readily grow into pores on the implant and bond with the implant, rather than reject the implant as a foreign substance. Finally, it would be very advantageous if the implant could have a useful life greater than seven to ten years, so that the implant could be successfully used in younger patients.

### SUMMARY OF THE INVENTION

The present invention provides a biocompatible implant comprising a substrate that includes a titanium or titanium alloy surface that comprises phosphorus atoms and oxygen atoms. In one embodiment, the phosphorus atoms are provided by a component selected from phosphorus, phosphorus oxides, titanium phosphorus oxides and combinations thereof. The phosphorus atoms may also be provided by phosphate. Preferably, the phosphorus atoms will have a concentration between about 1 mole % and about 15 mole % at the surface of the substrate. It is also preferable to have no electrochemically grown layer of titanium oxide between the substrate and the surface comprising phosphorus and oxygen. Advantageously, the titanium alloy may be Ti-6V-4Al or different titanium alloy that includes an element selected from molybdenum, zirconium, iron, aluminum, vanadium and combinations thereof. The implant may take many forms, but the implant specifically may be an orthopedic implant, a dental implant, an orthopedic fixation device, or a device selected from an orthopedic joint replacement and a prosthetic disc for spinal fixation. In an option embodiment, the substrate comprises a solid inner portion and a porous outer layer secured to the solid inner portion. Benficially, tissue can grow into pores in the porous outer layer. Furthermore, this tissue may be selected from, without limitation, bone, marrow and combinations thereof. It should be recognized that the porous outer layer may be made from the same material as the solid inner portion or a different material than the solid inner portion. In either case, the porous outer layer is preferably made from a material selected from titanium and titanium alloys. Optionally, the porous outer layer comprises sintered metal particles. It is also possible for the implant to further comprise a coating of hydroxyapatite deposited on internal surfaces and external surfaces of the porous outer layer without blocking the pores. The hydroxyapatite coating may be applied by a method selected from plasma deposition and electrodeposition.

In accordance with the implants of the present invention, the surface incorporates phosphorus to a depth that may be less than about 1 micron, such as between about 0.1 microns and about 0.9 microns, and more specifically between about 0.2 microns and about 0.5 microns. Alternatively, the surface may incorporate phosphorus to a depth between about 0.2 microns and about 5 microns, or between about 0.5 microns and about 5 microns.

Specifically, the present invention includes a biocompatible surgical implant, comprising a substrate with a surface comprising phosphorus and oxygen, wherein there is no electrochemically grown titanium oxide layer between the substrate and the surface comprising phosphorus and oxygen. The substrate is preferably a material selected from titanium, titanium alloys, and combinations thereof.

Further, the present invention includes a biocompatible surgical implant, consisting essentially of a titanium or titanium alloy member that has been treated by anodic phosphation.

Still further, the present invention includes, in relation to a surgical implant having a titanium or titanium alloy surface, the improvement consisting essentially of anodic phosphation of the surface. After the anodic phosphation, the surface is characterized in that it experiences a corrosion rate of less than 10 A/cm²×10⁻⁹ in contact with body fluids.

The present invention also provides a method, comprising performing anodic phosphation on a surface of a surgical implant, wherein the surface consists essentially of a metal selected from titanium, titanium alloy, or a combination thereof. The surgical implant formed by this method is also expressly included within the scope fo the present invention. In one embodiment, the step of performing anodic phosphation further comprises disposing the surface into a solution containing phosphate ions, and applying an anodic electrical potential to the surface. This method is characterized in that the surface is modified to comprise phosphorus and oxygen. The solution may included, without limitation, an electrolyte solution or an aqueous solution, such as an aqueous solution comprising greater than 10% water by volume or an aqueous solution of phosphoric acid. Preferably, the solution is substantially free from alcohol. A preferred solution is an aqueous phosphoric acid solution having a phosphoric acid concentration of between about 0.01 N and 5.0 N, most preferably between about 0.1 N and about 3.0 N. The temperature of the solution is preferably between about 15° C. and about 65° C. during the application of electrical potential, and more preferably between about 25° C. and about 55° C. during the application of electrical potential. Alternatively, the temperature of the solution is at least 25° C. during the application of electrical potential. The anodic phosphation should be performed on a surface that has no electrochemically grown layer of titanium oxide. The electrical potential may be, without limitation, between about 10 volts and about 150 volts, or between between about 25 volts and about 100 volts. Alternatively, the electrical potential may be greater than 25 volts. Specifically, it is preferred that the implant be subjected to the electrical potential for between about 15 seconds and about 1 hour, more specifically between about 1 minute and about 30 minutes. In another embodiment, the method may further comprise disposing the implant in a detergent before disposing the implant in the solution. In a still further embodiment, the method may further comprise removing passive oxide films from the surface of the implant before performing anodic phosphation, such as by disposing the implant in a fluoroboric acid solution. Optionally, the method may further comprise applying cathodic potential to a cathode in the solution, wherein the cathode material is selected from platinum, palladium, graphite, gold, titanium, platinized titanium, palladized titanium, and combinations thereof.

The present invention further provides a method comprising performing anodic phosphation on a titanium or titanium alloy surface of a surgical implant, the surface having no electrochemically grown layer of titanium oxide prior to anodic phosphation. The invention specifically includes the surgical implant formed by this method.

Still further, the invention provides a method for surface modification of a surgical implant, comprising performing anodic phosphation on a surgical implant having no electrochemically grown layer of titanium oxide. Preferably, the surgical implant is made of material selected from titanium, titanium alloys, and combinations thereof.

Additionally, the invention provides a method of preparing a biocompatible surgical implant, consisting essentially of performing anodic phosphation on a titanium or titanium alloy surgical implant.

In addition, the invention provides a method, comprising implanting a device into an animal or human, wherein the device comprises a titanium or titanium alloy external surface comprising phosphorus and oxygen. Preferably, the titanium or titanium alloy external surface comprises Ti-6V-4Al. Alternatively, the titanium alloy includes an element selected from molybdenum, zirconium, iron, aluminum, vanadium and combinations thereof. The device may be, without limitation, an orthopedic implant or a dental implant. Preferably, the external surface is porous, such as wherein tissue of the human or animal can grow into pores of the porous surface. Such the tissue includes, without limitation, tissue selected from bone, marrow and combinations thereof. Optionally, the porous external surface comprises sintered metal particles. As stated in other embodiments, the surface comprises phosphorus and oxygen. The depth of the phosphorus and/or oxygen penetration may vary, such as no more than about 1 micron, between about 0.1 microns and about 0.9 microns, between about 0.2 microns and about 0.5 microns, between about 0.1 microns and about 5 microns, or greater than about 1 micron.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a cross sectional view of an orthopedic surgical implant in accordance with the present invention.

### DETAILED DESCRIPTION

The present invention provides an apparatus that may be used as a biocompatible implant in human beings and animals. The present invention further provides a method for making a biocompatible implant. The implants may take many different shapes and forms, such as screws, wires, rods, plates, and tubes, but all the implants of the present invention have a substrate surface that has been electrochemically modified to comprise phosphorus, oxygen, and titanium. The substrate is a material selected from titanium and titanium alloys. Accordingly, it is not necessary to provide a coating or layer that physically covers the surface of the implant substrate.

The surface treatment that is performed on the implant includes anodic phosphation of the titanium or titanium alloy substrate. Anodic phosphation does not deposit or coat the surface of the implant with a coating, but rather converts or modifies the substrate surface through electrochemical reactions between the substrate, acting as an anode, and phosphate ions contained in an electrolyte solution, such as provided by an aqueous solution of phosphoric acid and water molecules. An advantage of this surface treatment over a coating is that the dimensions of the implant do not significantly change. This is important because the surface modification process allows the surgical implant substrate to be constructed to exact dimensions without having to account for the thickness of additional coatings being applied to the implant.

The anodic phosphation surface treatment incorporates phosphorus atoms and oxygen atoms into a portion of the titanium or titanium alloy substrate. Without being limited to any particular theory of the composition at the substrate surface, it is believed that the anodic phosphation surface treatment incorporates phosphate-like species and/or derivatives of phosphate into a portion of the titanium or titanium alloy substrate and may additionally convert some of the titanium atoms at the surface of the substrate to titanium oxide. Regardless of the exact composition or structure of the modified surface is not known with certainty, the concentration of the phosphorus-containing species, such as phosphate, derivatives of phosphate, and/or titanium phosphorus oxides, at the surface of the substrate is preferably between about 1 mole % and about 15 mole %. The surface treatment preferably incorporates phosphorus-containing species into the substrate to a depth of between about 0.2 μm and about 0.5 μm. Deeper penetrations are possible up to about 5 μm.

Perhaps the most important characteristic provided by the surface treatment of the present invention is the biocompatibility of the surface that has been modified to contain phosphates and/or derivatives of phosphate. Not only does the phosphate surface treatment provide the substrate with a strong protection against corrosion, it also provides extreme biocompatibility. This biocompatible implant provides a surface that is suitable for in-growth of bone tissue, thereby helping to securely anchor the surgical or dental implant to existing bone. A porous layer may be provided to the implant initially to host new tissue growth by covering at least a portion of the surface of the implant with metal spheres made of titanium or a titanium alloy. Rejection of the implant by the body is minimized and the useful life of the implant is increased because the implant is surrounded with in-grown tissue. The porous outer layer bonded to the solid inner portion of the implant may be of the same material as the solid inner portion or it may be of a different material.

Another important benefit provided by the surface treatment of the present invention is the increased corrosion resistance that the treatment provides to the substrate. There is concern for the toxicological effects of corrosion products that are released from implants into the body and contaminate adjoining tissue. In general, metal toxicity can result in metabolic alterations, alterations in host/parasite interactions, immunological interactions, non-specific immunological suppression due to the antichemotactic properties, and chemical carcinogenesis. The surface treatment of the present invention provides excellent corrosion protection for an implant and minimizes toxicological effects.

The greater the phosphorus concentration (phosphate-like species and/or derivatives of phosphate) present in the surface of the implant, the greater is both the resistance to corrosion and the biocompatibility. The phosphorus concentration may be controlled during the electrolytic surface treatment using voltage, electrolysis time, temperature and concentration of the H₃PO₄ used as the electrolyte. By controlling these parameters, the concentration of phosphorus in the surface of an implant may vary from less than 1.5 mole % to greater than 8.5 mole %. Table 1 illustrates how the percentage of phosphorus in the surface is affected as cell voltage (potential), time, temperature and concentration of the phosphoric acid are varied during the electrolysis procedure.

TABLE I
Summary of Corrosion Resistance Data

| | | CORROSION | CORROSION | POLARIZATION |
|---|---|---|---|---|
| | | RATE | POTENTIAL | RESISTANCE |
| PARAMETERS FOR PHOSPHATION | | (A/cm² × 10⁻⁹) | (V) | (ohms/cm² × 10⁻⁵) |
| Ti-6A1-4V WITHOUT PHOSPHATE LAYER | | 88 | −0.353 | 1.94 |
| POTENTIAL, E (V) | 25 | 6.5 | −0.082 | 2.53 |
| t = 3 min; T = 25° C.; C = 1.0 N | 50 | 4.9 | −0.037 | 4.78 |
| | 75 | 3.4 | +0.098 | 7.66 |
| | 100 | 1.9 | +0.290 | 10.9 |
| TIME, t (min) | 1 | 7.7 | −0.105 | 2.32 |
| E = 25 V; T = 25° C.; C = 1.0 N | 10 | 6.2 | −0.040 | 3.23 |
| | 30 | 4.4 | +0.015 | 5.26 |
| TEMPERATURE, T (° C.) | 35 | 4.8 | 0.047 | 4.89 |
| E = 25 V; t = 3 min; C = 1.0 N | 45 | 3.1 | 0.103 | 8.23 |
| CONCENTRATION OF H3PO4, c (N) | 0.1 | 21 | −0.197 | 2.07 |
| E = 25 V; t = 3 min; T = 25° C. | 0.5 | 9.2 | −0.135 | 2.37 |
| | 3.0 | 4.1 | +0.075 | 6.47 |

Corrosion rates were also measured in a solution that simulated body fluids (blood and tissue). Ethylenediaminetetraecetate, EDTA, was chosen as a complexing agent to model or simulate the effects of proteins and biomolecules on the solution kinetics. Solution kinetics were studied in 8 mM EDTA with a simulated interstitial electrolyte consisting of various salts, NaCl, CaSO₄, CaCl₂, and glucose. 4.5 mM glucose was added to simulate its normal concentration in blood. This solution simulates the activity of serum with the use of EDTA as the chelating agent for the metal ions released from the metal surface of the substrate in vivo so that these ions do not remain in solution around the metal surface. Rather, the metal ions form complex molecules that are transported away from the metal surface through motion of the fluid. As a result, steady state equilibrium of the dissolution and reprecipitation is never achieved. The rates of corrosion in this simulated environment are shown in Table 1.

It is seen that the control coupon (non-treated Ti-6Al-4V) exhibits a much more negative open-circuit potential than all the other phosphated electrodes, indicating that untreated samples are more likely to corrode than those that are phosphated.

The impedance responses obtained for the phosphated titanium surfaces are similar in shape but different in size as shown in Table 1. This indicates that the same fundamental process occurred on all the specimens, with a different corrosion protection in each case. Since the resistive contribution is directly proportional to corrosion protection (e.g. higher resistance gives higher corrosion protection), it is evident from Table 1 that phosphated metal surfaces show improved corrosion resistance with much higher values of polarization resistance (R_{ct}). In addition, corrosion rates corresponding to high polarization resistance of the phosphated metal surfaces are smaller than that of the specimens that were not treated by a factor of six. These studies show that the phosphated metal surfaces in contact with EDTA/SIE are corrosion resistant and that this corrosion resistance is directly proportional to the phosphate concentration in the metal surface.

The wear behavior of the control titanium sample as well as the titanium samples phosphated at 25, 75, and 100 V were performed using a pin-on-disk test rig. Flat Ti6Al4V disks were mechanically ground with diamond paste, followed by a silicon polishing solution. A mirror quality finish with an average surface roughness (Rₐ) less than 0.03 μm was obtained. Titanium disks and pins made of ultra-high molecular weight polyethylene (UHMWPE, contact area 1.5 mm²) and physiological solution (EDTA/SIE) as lubricant were used in wear testing. Constant normal force (F_{N}) of 15 N was applied, resulting in a pressure of 10 MPa. A sliding velocity of 5 cm/s and test durations of up to 36 hours were chosen. To determine the coefficient of friction, μ (μ=F_{R}/F_{M}), the friction force, F_{R}, was recorded during the experiments. Volumetric UHMWPE wear was determined by measuring the decrease in the length of the pins using a digital caliper (resolution of 0.01 mm). The sliding surfaces and the wear particles were investigated using light microscopy. Although pin-on-disk experiments do not replicate the tribological conditions in vivo (with respect to type on motion dynamic loading), they have been known to be used as cleaning tests.

The untreated control coupon showed severe wear with rupturing of the titanium surface and abrasion of black particles after only a few revolutions. While the sample treated at 25 V showed moderate abrasion, samples treated at 75 and 100 V showed smooth features after 5×10⁴ revolutions.

Titanium may be alloyed with several different elements to provide a preferred alloy for implants. These elements may be, for example, molybdenum, zirconium, iron, aluminum, vanadium and combinations thereof.

The implants of the present invention may be of any type, such as orthopedic implants or dental implants. Specifically, the orthopedic implants may include, without limitation, a fixation device, an orthopedic joint replacement or a prosthetic disc for spinal fixation.

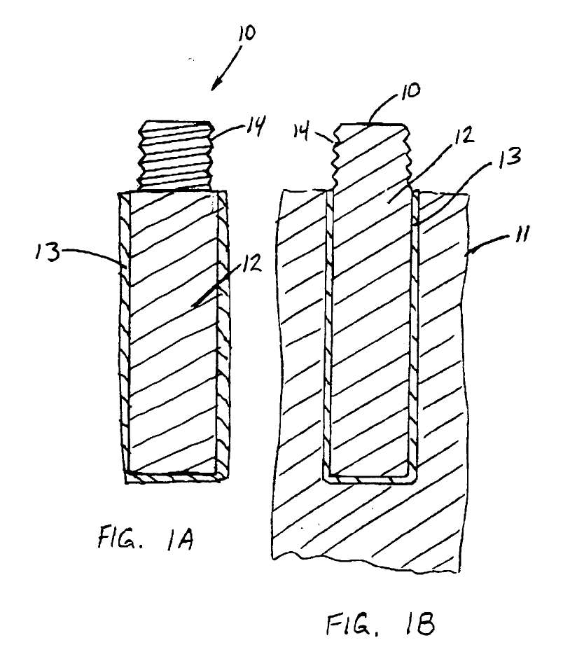

FIG. 1A is a side view of an orthopedic surgical implant 10 in accordance with the present invention and FIG. 1B is a cross-sectional view of the same orthopedic surgical implant 10 shown imbedded in the end of a bone 11. The implant 10 comprises an inner portion 12 surrounded by a porous layer 13 that is bonded to the inner portion 12 that is typically a solid or has very little porosity. The porous layer 13 shown here may be made of small diameter metal spheres that have been sintered together to form a very porous layer or shell 13. An optional threaded connection 14 is shown at one end for coupling the implant 10 with other implant devices, such as an artificial joint.

The surface modification method of the present invention is performed on a surgical implant made of material selected from titanium, titanium alloys, and combinations thereof. In accordance with an optional but preferred pretreatment before the surface modification, the implant is first submerged in an aqueous industrial detergent with light sonication to remove oil and dirt from the surface. After rinsing with deionized water, the implant is bead blasted or otherwise treated (etched, polished, or buffed) to remove unwanted inorganic-based or organic-based surface layers or films to prepare for the surface treatment. Roughening the metal surface facilitates the accumulation of phosphate-like species at the implant surface during the surface treatment. The final step of the pretreatment is to immerse the implant into a 10% solution, of HBF₄ for about one minute to remove any passive oxide film from the surface of the implant. Any acid, but preferably an acid having a fluorine-containing anion, may be used to remove the passive oxide film so long as the acid does not damage the implant.

After washing any remaining acid from the implant, the implant is submerged as the anode in the electrolyte of an electrolytic cell. The electrolyte may be any phosphate ion-containing solution, but aqueous H₃PO₄ is the preferred electrolyte. The cathode may be made of any material, preferably selected from platinum, palladium, gold, titanium, graphite, platinized titanium, and palladized titanium, but platinized titanium is the most preferred cathode material. A DC voltage is then applied across the electrolytic cell for the required period of time to provide the surface treatment or modification.

The amount of phosphate-like species incorporated in the surface of the implant at the end of the surface treatment is dependent upon process conditions, such as the concentration of phosphate ions in the electrolyte, the time that the implant spent in the electrolytic cell, the temperature of the cell, and the applied voltage across the cell. The phosphate ion concentration in the electrolyte is preferably between about 0.01 N and about 3.5 N. More preferably, the concentration of phosphate ions in the electrolyte is between about 0.1 N and about 3 N. The temperature of the electrolyte is preferably maintained at a temperature between about 15° C. and about 65° C., most preferably between about 25° C. and about 55° C. The applied cell voltage is preferably maintained between about 10 V and about 150 V, most preferably between about 25 V and about 100 V. The surface treatment is preferably performed over a time period of between about 15 seconds and about 1 hour, most preferably between about 1 minute and about 30 minutes.

### EXAMPLE 1

A titanium alloy coupon made of the alloy Ti-6A1-4V and measuring 3.81 cm×5.08 cm×0.2 cm was immersed in an aqueous industrial detergent and sonicated for about 30 minutes to remove surface oil and dirt. After rinsing with deionized water, the coupon was bead-blasted at about 40 to 60 psi to roughen the coupon. After again rinsing with deionized water, the coupon was then immersed in a 10% solution of HBF₄ for about 1 minute, to remove the passive oxide film.

After again washing with deionized water, the coupon was placed in an electrolytic cell as the anode. The electrolyte in the cell was an aqueous solution of 1.0 N H₃PO₄, the applied voltage was 50 volts, and the voltage was applied for 3 minutes at an electrolyte temperature of 25° C. The coupon was then removed from the cell and exhibited a strong gold color on the surface. The coupon was rinsed with deionized water to remove traces of the mineral acid.

### EXAMPLE 2

Using the same size Ti-6Al-4V coupon and pretreatment steps as in Example 1, a coupon was placed in an electrolytic cell as the anode. The electrolyte in the cell was an aqueous solution of 1.0 N H₃PO₄, the applied cell voltage was 75 volts, and the voltage was applied for 3 minutes at an electrolyte temperature of 25° C. The coupon was then removed from the cell bearing a strong purple color on the surface. The coupon was rinsed with deionized water to remove traces of the mineral acid.

### EXAMPLE 3

A cylindrical coupon of Ti-6Al-4V measuring 3.81 cm in diameter and 0.15 cm in thickness was immersed in an aqueous industrial detergent and sonicated for 30 minutes. The coupon was polished with a diamond paste to a mirror finish and then immersed in a 10% HBF₄ solution for about 1 minute to remove the passive oxide film. After washing with deionized water, the coupon was placed in an electrolytic cell as the anode. The electrolyte in the cell was an aqueous solution of 1.0 N H₃PO₄, the applied voltage was 25 volts, and the voltage was applied for 3 minutes at an electrolyte temperature of 25° C. The coupon was then removed from the cell bearing a stong blue color on the surface. The coupon was rinsed with deionized water to remove traces of the mineral acid.

### EXAMPLE 4

Seven implants having a Ti-6Al-4V alloy core covered with a porous titanium layer bonded to the alloy surface were pretreated as in Example 1. The implants were hip replacement prostheses custom made by Wright Medical Technology of Arlington, Tenn. Each implant was placed in an electrolytic cell as the anode. The electrolyte in the cell was an aqueous solution of 0.33 N H₃PO₄, the applied voltage was 50 volts, and the voltage was applied for 30 minutes at an electrolyte temperature of 25° C. The implants emerged from the cells having the same strong gold color as the coupon in Example 1.

The treated implants were inserted into the proximal humerus of seven dogs. An additional seven implants, which were not treated, were inserted in seven other dogs as a control group. After 6 months, the amount of various tissues surrounding the implants and within the porous layer was quantified from histological sections. As my be seen from Table 2, the implants having the phosphate surface treatment had significantly more bone and marrow tissue and less fibrous tissue within the porous layer than the control implant group.

TABLE 2
Percent Tissue at the Substrate

| | Sample No. | Bone | Marrow | Fibrous | Metal Beads |
|---|---|---|---|---|---|
| Electrolytic | 1 | 26.2 | 18.0 | 35.8 | 19.9 |
| Phosphate | 2 | 24.4 | 19.0 | 31.9 | 24.6 |
| Surface | 3 | 18.5 | 18.0 | 41.7 | 21.8 |
| Treated | 4 | 52.3 | 21.7 | 4.6 | 21.4 |
| Implants | 5 | 17.6 | 13.4 | 42.8 | 26.2 |
| | 6 | 44.2 | 13.8 | 22.0 | 20.1 |
| | 7 | 12.9 | 4.5 | 62.5 | 20.1 |
| | MEAN | 28.0 | 15.5 | 34.5 | 22.0 |
| Untreated | 1 | 0.0 | 0.0 | 84.6 | 15.4 |
| Control | 2 | 4.2 | 3.3 | 71.1 | 21.4 |
| Implants | 3 | 25.3 | 9.9 | 44.5 | 20.3 |
| | 4 | 9.4 | 3.9 | 64.2 | 22.6 |
| | 5 | 12.1 | 16.2 | 45.2 | 26.6 |
| | 6 | 17.8 | 3.8 | 58.9 | 19.5 |
| | 7 | 9.2 | 2.4 | 64.9 | 23.6 |
| | MEAN | 11.1 | 5.6 | 91.9 | 21.3 |

### Example 5

Coupons of Ti-6Al-4V titanium alloy, measuring 50 mm×10 mm×2 mm were surface treated using the method described in Example 1. Each of the samples was exposed to varying conditions of electrolyte temperature, cell voltage, anodic phosphation processing time and phosphoric acid concentration during the electrolysis as shown in Table 3. Hydroxyapatite was then deposited on each of the surface-modified coupons, as well as non-surface-treated coupons, using plasma deposition.

The plasma deposition method included using an atmospheric plasma spraying technique. Argon was used as the carrier gas with the plasma reaching temperatures near 5000 ° C. The coupon was kept at a temperature under 300° C. to preserve the original mechanical properties of the metal substrate, including the modified surface. A α-β acicular microstructure was produced, presenting a yield strength of 865 MPa and an elongation of 16%.

Adhesion and tensile tests were performed on the control coupons and phosphated Ti-6Al-4V coupons according to a modification of ASTM C 633 test, which includes coating one face of a substrate fixture, bonding this coating to the face of a loading fixture, and subjecting this assembly of coating and fixtures to a tensile load normal to the plane of the coating. Each sample was glued to an upper roughened titanium grid by a special adhesive bonding glue (METCO EP 15), which is a commercial high viscosity dental bonding agent.

As may be seen from the results shown in Table 3, the value of the tensile strength increased with the increase of the phosphate concentration in the modified surface of the titanium sample. Furthermore, the phosphate surface modification tended to improve the bonding strength between the coupon and the hydroxyapatite coating by a factor of 2 when compared with the non-phosphated coupons.

TABLE 3
Tensile Strength of Hydroxyapatite-Coated Samples

| | | Tensile Strength (MPa) |
|---|---|---|
| PARAMETERS FOR ANODIC PHOSPHATE | | Plasma Deposited |
| SURFACE MODIFICATION | | Hydroxyapatite |
| Potential (E(V)) | 25 V | 13.24 |
| t = 3 min; T = 25° C.; C = 1.0 N | 50 V | 18.36 |
| | 75 V | 20.75 |
| | 100 V | 23.51 |
| Time (t (min)) | 1 min | 11.47 |
| E = 25 V; T = 25° C.; C = 1.0 N | 10 min | 15.56 |
| | 30 min | 18.87 |
| Temperature (T(° C.)) | 35° C. | 17.92 |
| E = 25 V; t = 3; C = 1.0 N | 45° C. | 21.17 |
| Concentration of P₃O₄ (C(N)) | 0.1 N | 10.92 |
| E = 25 V; t = 3 min; T = 25° C. | 0.5 N | 12.21 |
| | 3.0 N | 20.56 |
| Control - No Phosphate Layer | | 10.32 |

It should be understood from the foregoing description that various modifications and changes may be made in the preferred embodiment of the present invention without departing from its true spirit. It is intended that this description is for purposes of illustration only and should not be construed in a limiting sense. Only the language of the following claims should limit the scope of this invention.

What is claimed is:

1. A biocompatible implant, comprising:
a substrate including a titanium or titanium alloy surface comprising phosphorus atoms and oxygen atoms.

2. The implant of claim 1, wherein the phosphorus atoms are provided by a component selected from phosphorus, phosphorus oxides, titanium phosphorus oxides and combinations thereof.

3. The implant of claim 1, wherein a portion of the phosphorus atoms are provided by phosphate.

4. The implant of claim 1, wherein the phosphorus atoms have a concentration between about 1 mole % and about 15 mole % at the surface of the substrate.

5. The implant of claim 1, wherein there is no electrochemically grown layer of titanium oxide between the substrate and the surface comprising phosphorus and oxygen.

6. The implant of claim 1, wherein the titanium alloy is Ti-6V-4Al.

7. The implant of claim 1, wherein the titanium alloy includes an element selected from molybdenum, zirconium, iron, aluminum, vanadium and combinations thereof.

8. The implant of claim 1, wherein the implant is an orthopedic implant.

9. The implant of claim 1, wherein the implant is a dental implant.

10. The implant of claim 1, wherein the implant is an orthopedic fixation device.

11. The implant of claim 1, wherein the implant is a device selected from an orthopedic joint replacement and a prosthetic disc for spinal fixation.

12. The implant of claim 1, wherein the substrate comprises:
a solid inner portion; and
a porous outer layer secured to the solid inner portion.

13. The implant of claim 12, wherein tissue can grow into pores in the porous outer layer.

14. The implant of claim 13, wherein the tissue is selected from bone, marrow and combinations thereof.

15. The implant of claim 12, wherein the porous outer layer is made from the same material as the solid inner portion.

16. The implant of claim 12, wherein the porous outer layer is made from a different material than the solid inner portion.

17. The implant of claim 12, wherein the porous outer layer is made from a material selected from titanium and titanium alloys.

18. The implant of claim 17, wherein the porous outer layer comprises sintered metal particles.

19. The implant of claim 1, further comprising:
a coating of hydroxyapatite deposited on internal surfaces and external surfaces of the porous outer layer without blocking the pores.

20. The implant of claim 19, wherein the hydroxyapatite coating is applied by a method selected from plasma deposition and electrodeposition.

21. The implant of claim 1, wherein the surface incorporates phosphorus to a depth of less than about 1 micron.

22. The implant of claim 1, wherein the surface incorporates phosphorus to a depth between about 0.1 microns to about 0.9 microns.

23. The implant of claim 1, wherein the surface incorporates phosphorus to a depth between about 0.2 microns and about 0.5 microns.

24. The implant of claim 1, wherein the surface incorporates phosphorus to a depth between about 0.2 microns and about 5 microns.

25. The implant of claim 1, wherein the surface incorporates phosphorus to a depth between about 0.5 microns and about 5 microns.

26. The implant of claim 1, wherein the surface incorporates phosphorus to a depth greater than about 1 micron.

27. A biocompatible surgical implant, comprising:
a substrate with a surface comprising phosphorus and oxygen, wherein there is no electrochemically grown titanium oxide layer between the substrate and the surface comprising phosphorus and oxygen.

28. The implant of claim 27, wherein the substrate is a material selected from titanium, titanium alloys, and combinations thereof.

29. A biocompatible surgical implant, consisting essentially of a titanium or titanium alloy member that has been treated by anodic phosphation.

30. In a surgical implant having a titanium or titanium alloy surface, the improvement consisting essentially of anodic phosphation of the surface.

31. The implant of claim 30, wherein the surface experiences a corrosion rate of less than 10 A/cm²×10⁻⁹ in contact with body fluids.

32. A method, comprising:
performing anodic phosphation on a surface of a surgical implant, wherein the surface consists essentially of a metal selected from titanium, titanium alloy, or a combination thereof.

33. The surgical implant formed by the method of claim 32.

34. The method of claim 32, wherein the step of performing anodic phosphation further comprises:
disposing the surface into a solution containing phosphate ions; and
applying an anodic electrical potential to the surface.

35. The method of claim 34, characterized in that the surface is modified to comprise phosphorus and oxygen.

36. The method of claim 34, wherein the solution is an electrolyte solution.

37. The method of claim 34, wherein the solution is aqueous.

38. The method of claim 37, wherein the aqueous solution comprises greater than 10% water by volume.

39. The method of claim 34, wherein the solution is substantially free from alcohol.

40. The method of claim 34, wherein the solution is an aqueous solution of phosphoric acid.

41. The method of claim 40, wherein the concentration of the aqueous phosphoric acid solution is between about 0.01 N and 5.0 N.

42. The method of claim 40, wherein the concentration of the aqueous phosphoric acid solution is between about 0.1 N and about 3.0 N.

43. The method of claim 34, wherein the temperature of the solution is between about 15° C. and about 65° C. during the application of electrical potential.

44. The method of claim 34, wherein the temperature of the solution is between about 25° C. and about 55° C. during the application of electrical potential.

45. The method of claim 34, wherein the temperature of the solution is at least 25° C. during the application of electrical potential.

46. The method of claim 32, wherein the surface has no electrochemically grown layer of titanium oxide.

47. The surgical implant formed by the method of claim 46.

48. The method of claim 34, wherein the electrical potential is between about 10 volts and about 150 volts.

49. The method of claim 34, wherein the electrical potential is between about 25 volts and about 100 volts.

50. The method of claim 34, wherein the electrical potential greater than 25 volts.

51. The method of claim 34, wherein the implant is subjected to the electrical potential for between about 15 seconds and about 1 hour.

52. The method of claim 34, wherein the implant is subjected to the electrical potential for between about 1 minute and about 30 minutes.

53. The method of claim 34, further comprising:
disposing the implant in a detergent before disposing the implant in the solution.

54. The method of claim 32, further comprising:
removing passive oxide films from the surface of the implant before performing anodic phosphation.

55. The surgical implant formed by the method of claim 54.

56. The method of claim 54, wherein the passive oxide films are removed by disposing the implant in a fluoroboric acid solution.

57. The method of claim 34, further comprising:
applying cathodic potential to a cathode in the solution, wherein the cathode material is selected from platinum, palladium, graphite, gold, titanium, platinized titanium, palladized titanium, and combinations thereof.

58. A method, comprising:
performing anodic phosphation on a titanium or titanium alloy surface of a surgical implant, the surface having no electrochemically grown layer of titanium oxide prior to anodic phosphation.

59. The surgical implant formed by the method of claim 58.

60. A method for surface modification of a surgical implant, comprising:
performing anodic phosphation on a surgical implant having no electrochemically grown layer of titanium oxide.

61. The method of claim 60, wherein the surgical implant is made of material selected from titanium, titanium alloys, and combinations thereof.

62. A method of preparing a biocompatible surgical implant, consisting essentially of performing anodic phosphation on a titanium or titanium alloy surgical implant.

63. A method, comprising:
implanting a device into an animal or human, wherein the device comprises a titanium or titanium alloy external surface comprising phosphorus and oxygen.

64. The method of claim 63, wherein the titanium or titanium alloy external surface comprises Ti-6V-4Al.

65. The method of claim 63, wherein the titanium alloy includes an element selected from molybdenum, zirconium, iron, aluminum, vanadium and combinations thereof.

66. The method of claim 63, wherein the device is an orthopedic implant.

67. The method of claim 63, wherein the device is a dental implant.

68. The method of claim 63, wherein the external surface is porous.

69. The method of claim 68, wherein tissue of the human or animal can grow into pores of the porous surface.

70. The method of claim 69, wherein the tissue is selected from bone, marrow and combinations thereof.

71. The method of claim 68, wherein the porous external surface comprises sintered metal particles.

72. The method of claim 1, wherein the surface comprises phosphorus and oxygen to a depth of no more than about 1 micron.

73. The method of claim 1, wherein the surface comprises phosphorus and oxygen to a depth between about 0.1 microns and about 0.9 microns.

74. The method of claim 1, wherein the surface comprises phosphorus and oxygen to a depth between about 0.2 microns and about 0.5 microns.

75. The method of claim 1, wherein the surface comprises phosphorus and oxygen to a depth between about 0.1 microns and about 5 microns.

76. The method of claim 1, wherein the surface comprises phosphorus and oxygen to a depth greater than about 1 micron.
